(19) United States
(12) Patent Application Publication
(10) Pub. No.: US 2022/0081362 A1
(43) Pub. Date: Mar. 17, 2022

(54) CEMENT MODIFIER COMPOSITIONS

(71) Applicants: Dow Global Technologies LLC, Midland, MI (US); Rohm & Haas Company, Collegeville, PA (US); Dow Produktions Und Vertriebs GMBH & Co. OHG, Wiesbaden (DE)

(72) Inventors: Margarita Perello, Horgen (CH); Ligeng Yin, Collegeville, PA (US); Sonja Menz, Bomlitz (DE); Joerg Neubauer, Bomlitz (DE); Jing Meng, Collegeville, PA (US)

(73) Assignees: Dow Global Technologies LLC, Midland, MI (US); Rohm & Haas Company, Collegeville, PA (US); Dow Produktions Und Vertriebs GMBH & Co. OHG, Wiesbaden (DE)

(21) Appl. No.: 17/442,845

(22) PCT Filed: Mar. 25, 2020
(86) PCT No.: PCT/US2020/024683

§ 371 Date: Sep. 24, 2021

Related U.S. Application Data
(60) Provisional application No. 62/823,983, filed on Mar. 26, 2019.

(51) Int. Cl. C04B 20/10; C04B 24/26; C04B 28/14; C04B 18/02

(52) U.S. Cl. CPC C04B 20/1033; C04B 24/2641; C04B 24/2688; C04B 2103/0054; C04B 28/14; C04B 18/022; C04B 24/2623

(57) ABSTRACT

Described herein are emulsion polymers, spray dried powders made with said emulsion polymers, and cementitious compositions made with said emulsion polymers or said spray dried powders. Emulsion polymers described herein comprise a shell portion comprising an alkali soluble resin (ASR), a core portion formed from polymerized units of at least one hydrophobic ethylenically unsaturated monomer, wherein no crosslinker is present when the shell portion and core portion are combined, and a nonionic water-soluble polymer.

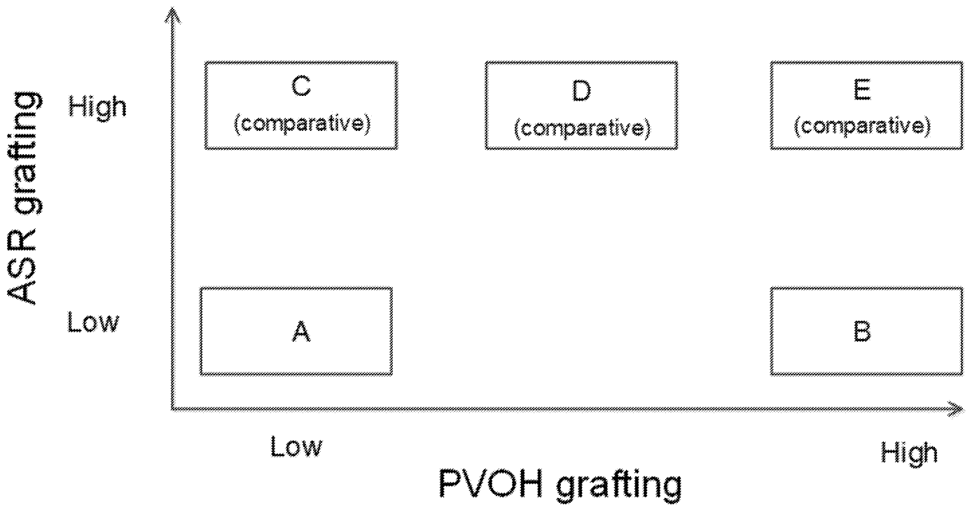

### CROSS-REFERENCE TO RELATED APPLICATIONS

This application claims the benefit of U.S. Provisional Application No. 62/823,983, filed Mar. 26, 2019, the contents of which are hereby incorporated herein by reference in its entireties.

### BACKGROUND

Water redispersible polymers (RDP), whether in the form of a wet latexes or spray dried powder, are often added in hydraulic binders (such as, for example, mortars and concrete) to improve the performance of a cementitious product. One example of a commercial cement modifier that offers performance benefits is DRYCRYL™ acrylic, redispersible powder (available from The Dow Chemical Company, Midland, Mich.).

It is an important goal in the industry to continue to identify compositions that improve performance of a cementitious product. Improved performance of a cementitious product may include improving one or more of: properties of the wet mortar, for example, water demand, density, and/or workability; and/or properties of the cured products, for example, adhesion, mechanical strength, tensile and elongation, crack bridging, and/or water uptake/resistance.

### SUMMARY

Described herein are emulsion polymers, spray dried powders made with said emulsion polymers, and cementitious compositions made with said emulsion polymers or said spray dried powders. Emulsion polymers described herein comprise a shell portion comprising an a kali soluble resin (ASR), a core portion formed from polymerized units of at least one hydrophobic ethylenically unsaturated monomer, wherein no crosslinker is present when the shell portion and core portion are combined, and a nonionic water-soluble polymer.

### BRIEF DESCRIPTION OF THE DRAWINGS

A diagram characterizing the degree of grafting in water redispersible polymer (RDP) powders.

### DETAILED DESCRIPTION

A water redispersible polymer (RDP) powder may be produced from a core-shell polymer. For example, a latex may be made via emulsion polymerization. The latex may be converted to the dry grade by spray drying. The latex precursor may be core-shell structured. The core may be soft and hydrophobic, and may serve as the film-forming component of the polymer for performance enhancement. The shell may be hard and hydrophilic, and may serve to protect the core from irreversible coagulation during spray drying and storage.

In an embodiment an emulsion polymer is described. The emulsion polymer comprises a shell portion comprising an alkali soluble resin (ASR), a core portion formed from polymerized units of at least one hydrophobic ethylenically unsaturated monomer, wherein no crosslinker is present when the shell portion and core portion are combined, and a nonionic water-soluble polymer. Examples of crosslinkers include polyfunctional monomers, which includes allyl methacrylate (ALMA).

It is understood that the emulsion polymer is a core-shell polymer (e.g., as opposed to physical blends of monomers that may be found in ASRs and/or hydrophobic ethylenically unsaturated monomers (or resins therefrom), or single stage polymers containing a mix of monomers described herein with respect to the shell portion and core portion). In an embodiment the emulsion polymer may be formed in a two-stage polymerization. For example, the shell portion and the core portion may be prepared as separate monomer emulsions. The nonionic water-soluble polymer may be added to the shell monomer emulsion, the core monomer emulsion, or after combination of the shell monomer emulsion and the core monomer emulsion (e.g., cold blended). In a preferred embodiment the non ionic water-soluble polymer is added to the shell monomer emulsion before the shell monomer emulsion and the core monomer emulsion are combined.

As regarding order of addition, the emulsion polymer may be formed in a two-stage polymerization comprising a first stage polymerization of the shell portion (in which no crosslinker is used in first stage) and a second stage polymerization of the core portion. In this embodiment after the first stage polymerization is complete, no unreacted functional groups are left to react with the subsequent core stage to form covalent linkages between the core and ASR containing shell (e.g., ASR grafting).

Alternatively, the emulsion polymer may be formed in a two-stage polymerization comprising a first stage polymerization of the core portion (in which no crosslinker is used in first stage) and a second stage polymerization of the ASR shell portion. Again, after the first stage polymerization is complete, no unreacted functional groups are left to react with the subsequent core stage to form covalent linkages between the core aid ASR containing shell (e.g., ASR grafting).

As will be described, although relatively high levels of ASR grafting lead to colloidal stability, and hence crosslinkers were previously thought to be crucial. As illustrated in the Examples, Applicants have surprisingly found that low levels of ASR grafting are desirable. For example, Applicants found that when no crosslinker is included, the polymer stability (e.g., during emulsion polymerization or spray drying) was acceptable. Moreover, the flexibility of the resulting cementitious compositions (e.g., mortar membranes) was improved. In an embodiment the emulsion polymer exhibits a low level of ASR grafting.

In an embodiment the ASR is formed from polymerized units of at least one add-functional monomer, anhydride-functional monomer, salts thereof, or a combination thereof. The ASR may be anionic and/or may become water-soluble in alkaline conditions. In an embodiment the ASR may be free of, or substantially free (e.g., at a lower concentration than would be considered to impart functionality (such as, for example, less than 0.5 weight percent)) of, polymerized units of hydroxyl-containing monomers. Preferably, the ASR is formed from polymerized units of at least one (e.g., one or more) add-functional monomer comprising Methyl methacrylate (MMA) and Methacrylic add (MAA). More preferably, the ASR is formed from polymerized units of MMA and MAA.

The ASR may be formed from polymerized units of at least one add-functional monomer at a level of from about 5 percent to about 50 percent preferably from about 10 percent to about 30 percent by mass of the total mass of ASR. For example, the preceding ranges refer to the mass percentage of the acid-functional monomer with respect to the total monomer for the ASR stage. In an embodiment the ASR comprises about 15 percent to about 30 percent of MAA, by solids content of the ASR.

In an embodiment the glass transition temperature (Tg) of the ASR in the add form is about 70° C. to about 140° C.

In an embodiment the ASR has a weight average molecular weight of 50,000 or less, for example, as measured by gel permeation chromatography. For clarity, in embodiments where a nonionic water-soluble polymer is combined with the monomer emulsion for the shell portion, this molecular weight of the ASR refers to the ASR before incorporation of the nonionic water-soluble polymer.

In an embodiment the at least one hydrophobic ethylenically unsaturated monomer in the core portion comprises alkyl (meth)acrylate, styrene, and/or a vinyl ether. In a preferred embodiment the at least one hydrophobic ethylenically unsaturated monomer comprises a mixture of butyl acrylate and styrene.

The core portion may further comprise one or more hydrophilic ethylenically unsaturated monomers including carboxylic add, anhydride, sulfonic add, phosphic add, amide group containing monomers, hydroxyalkyl, or methylolated monomers. In an embodiment the mass percent of hydrophilic monomers in the core portion is about 0% to about 5%.

The Tg of the core portion polymer is about −50° C. to about 60° C.

In an embodiment if the total of ASR and core is considered 100 parts, the mass ratio of ASR:core is in a range of about 2:98 to about 50:50. Preferably, the mass ratio of ASR:core is in a range of about 5:95 to about 20:80.

In an embodiment if the total of ASR and core is considered 100 parts (“ASR plus core”), the mass ratio of nonionic water-soluble polymer to ASR phis core is in a range of about 0.5 parts to about 20 parts nonionic water-soluble polymer to about 100 pats ASR plus core. Preferably, the mass ratio of nonionic water-soluble polymer to ASR plus core is in a range of about 1 part to about 10 parts.

In an embodiment the nonionic water-soluble polymer is polyvinyl alcohol (PVOH).

Preferably, the emulsion polymer exhibits a high level of PVOH grafting. This may be achieved by adding at least part of the PVOH in the process of polymerization, e.g., rather than making physical blends of PVOH with the post-polymerization core-shell latex.

The emulsion polymer may be made by forming a monomer emulsion for the shell portion, forming a monomer emulsion for the core portion, and combining the monomer emulsions in the absence of crosslinker. In an embodiment the non ionic water-soluble polymer is combined with the monomer emulsion for the shell portion before the monomer emulsions are combined. In another embodiment the non ionic water-soluble polymer is combined with the monomer emulsion for the core portion before the monomer emulsions are combined.

In an embodiment the emulsion polymer as described above (e.g., comprising a shell portion comprising an alkali soluble resin (ASR), a core portion formed from polymerized units of at least one hydrophobic ethylenically unsaturated monomer, wherein no crosslinker is present when the shell portion and core portion are combined, and a non ionic water-soluble polymer) may be converted to a spray dried powder. In an embodiment the spray dried powder is a water redispersible polymer (RDP). The spray dried powder may comprise the above-described emulsion polymer and a flow ad present in a range of about 1% to about 30%, preferably about 4% to about 20% by weight of the spray dried powder. For example, the flow aid may be Kaolin clay. As will be described with respect to the drawing, preferred spray dried powders exhibit a low level of ASR grafting. In an embodiment particularly preferred spray dried powders exhibit a high level of PVOH grafting.

Presently described emulsion polymers and/or spray dried powders may find use as part of cementitious compositions, improving, for example, one or more of: properties of the wet mortar, for example, water demand, density, and/or workability; and/or properties of the cured products, for example, adhesion, mechanical strength, tensile and elongation, crack bridging, and/or water uptake/resistance. In an embodiment the cementitious composition comprises an emulsion polymer and/or spray dried powder as described herein and Portland cement. In an embodiment the cementitious composition comprises an emulsion polymer and/or spray dried powder as described herein and a ternary hydraulic binder. In an embodiment the cementitious composition comprises a spray dried powder formed from an emulsion polymer comprising a shell portion comprising an alkali soluble resin (ASR), wherein the ASR is formed from polymerized units of at least one add-functional monomer comprising Methyl methacrylate (MMA) and Methacrylic add (MAA), a core portion formed from polymerized units of at least one hydrophobic ethylenically unsaturated monomer, wherein the at least one hydrophobic ethylenically unsaturated monomer comprises a mixture of butyl acrylate aid styrene, wherein no crosslinker is present when the shell portion and core portion are combined, and a nonionic water-soluble polymer, wherein the nonionic water-soluble polymer is added to the shell portion before the shell portion and core portion are combined, and Portland cement (e.g., alone or as part of a ternary hydraulic binder). In an embodiment the cementitious composition is characterized by one or more of superior mechanical properties for the tensile and elongation of membranes after 7 days at normal condition, after additional 7 days in water immersion, or crack bridging at room temperature (RT).

### EXAMPLES

### Example 1

A number of monomer emulsions (ME #1) were built in 2 L containers, the compositions as listed in TABLE 1:

TABLE 1

| | | | Example 1C | Example 1D | Example 1E |
|---|---|---|---|---|---|
| Ingredients (g) | Example 1A | Example 1B | (comparative) | (comparative) | (comparative) |
| Methyl methacrylate | 155.5 | 155.5 | 152.6 | 152.6 | 152.6 |
| (MMA) | | | | | |
| Allyl methacrylate | 0 | 0 | 2.96 | 2.96 | 2.96 |
| (ALMA) | | | | | |
| Methacrylic acid (MAA) | 39.4 | 39.4 | 39.4 | 39.4 | 39.4 |
| SIPONATE ™ DS-4 | 0.74 | 0.74 | 0.74 | 0.74 | 0.74 |
| (22.5%) emulsifier | | | | | |
| TEXANOL ™ ester | 19.4 | 19.4 | 19.4 | 19.4 | 19.4 |
| alcohol coalescent | | | | | |
| Methyl 3-mercapto | 6.80 | 6.80 | 6.80 | 6.80 | 6.80 |
| propionate (3-MMP) | | | | | |
| DI water | 246.5 | 246.5 | 246.5 | 246.5 | 246.5 |
| Total | 468.4 | 468.4 | 468.4 | 468.4 | 468.4 |

The monomer emulsions of TABLE 1 are examples of compositions that may be used to form the shell component of a core-shell polymer. In Examples 1A and 1B, the mass % of MAA (as compared to MAA+MMA) is about 20.2%.

### Example 2

A number of monomer emulsions (ME #2) were built in 4 L containers, the compositions as listed in TABLE 2:

TABLE 2

| | | | Example 2C | Example 2D | Example 2E |
|---|---|---|---|---|---|
| Ingredients (g) | Example 2A | Example 2B | (comparative) | (comparative) | (comparative) |
| Butyl acrylate (BA) | 1336.8 | 1336.8 | 1336.8 | 1336.8 | 1336.8 |
| Styrene (STY) | 279.5 | 279.5 | 279.5 | 279.5 | 279.5 |
| Methacrylamide (MAM) | 31.9 | 31.9 | 31.9 | 31.9 | 31.9 |
| Sodium lauryl sulfate | 11.9 | 11.9 | 11.9 | 11.9 | 11.9 |
| (SLS) surfactant (28%) | | | | | |
| Polyvinyl alcohol (PVOH) | 0 | 0 | 0 | 314.0 | 0 |
| 4-88 (15%) | | | | | |
| n-dodecyl mercaptan | 1.48 | 1.48 | 1.48 | 1.48 | 1.48 |
| (nDDM) | | | | | |
| DI water | 476.2 | 476.2 | 476.2 | 476.2 | 476.2 |
| Total | 2137.9 | 2137.9 | 2137.9 | 2451.8 | 2137.9 |

The monomer emulsions of TABLE 1 are examples of compositions that may be used to form the core component of a core-shell polymer.

### Example 3

Polymer A was formed as follows. 500 g of Dl water was charged in a reactor (5-L round-bottom flask equipped/connected with a mechanical stirrer, a thermocouple, a condenser, and pumps for feeding monomer emulsions and additive solutions) and heated to 58*C. For Stage 1 polymerization, Example 1A of ME #1 (from Example 1) was transferred to the reactor along with 34 g of Dl water as a rinse.

The reaction was initiated by charging the reactor with a solution of 0.022 g of FeSO₄.7H₂O aid 0.030 g of the tetrasodium salt of EDTA in 4.9 g of water, a solution of 3.83 g of t-butyl hydroperoxide (tBHP) (70% active) in 29.1 g of water, aid a solution of 3.03 g of BRUGGOLITE™ E-28 reducing agent (available from Bruggemann Chemical U.S., Inc., Newtown Square, Pa.) in 100 g of water, each separately as a shot addition. An exotherm of 20-25*C was observed over the next 10-15 min.

A solution of 0.61 g of tBHP (70% active) in 14.6 g of water and a solution of 0.75 g of BRUGGOLITE™ E-28 in 30 g of water was charged into the reactor aid the reaction was held for 15 min. After the hold, a slurry of 9.3 g of Ca(OH)₂ and 20.2 g of NaOH solution (50% active) in 97.0 g of water was added into the reactor and the reaction was held for another 10 min.

For Stage 2 polymerization, 240 g of Example 2A of ME #2 (from Example 2) was transferred to the reactor followed by shot additions of a solution of 3.04 g of sodium persulfate in 24.3 g of water and a solution of 2.10 g of sodium bisulfite in 24.3 g of water. An exotherm of 10-15° C. was observed over the next 6-12 min. The rest of Example 2A of ME #2 (from Example 2) was then metered into the reactor along with a solution of 4.75 g sodium persulfate and 0.137 g of tert-amyl hydroperoxide (85% active) in 127.1 g of water and a solution of 6.83 g of sodium bisulfite in 127.1 g of water as separate feeds. The feeding time for Stage 2 was 150 min. The temperature was controlled at 75±1° C.

When the feeds were completed, the reaction was cooled to 65° C. A solution of 0.011 g of FeSO₄.7H₂O and 0.015 g of the tetrasodium salt of EDTA in 4.9 g of water was charged into the reactor as a shot addition. A solution of 2.51 g of tBHP (70% active) in 70.0 g of water and a solution of 2.18 g of BRUGGOLITE™ FF6 reducing agent (available from Bruggemann Chemical U.S., Inc., Newtown Square, Pa.) in 70.0 g of water was metered into the reactor over 60 min.

314 g of polyvinyl alcohol (PVOH 4-88) (15 wt %) solution was metered in over 15 min. The reactor was finally charged with a solution of 1.94 g of KORDEK™ LX5000 biocide (available from DuPont Wilmington, Del.) in 4.9 g of water. The latex was filtered to remove any large coagulum. Basic characteristics: solid content 44.1%, pH: 7.5.

### Example 4

Polymer B was formed by a procedure similar to that of Example 3, except Example 1B (from Example 1) was used for Stage 1 polymerization, and that the PVOH solution was added after the hold following neutralizer slurry addition and before the charge of Example 2B of ME #2 (from Example 2) seed. Basic characteristics: solid: 44.4%, pH: 7.8.

### Example 5 (Comparative)

Polymer C was formed by a procedure similar to that of Example 3. However, the composition of ME #1 was different (comparative Example 1C (from Example 1) was used) aid it contained a crosslinker, ALMA Basic characteristics: solid: 43.1%, pH: 7.88.

### Example 6 (Comparative)

Polymer D was formed by a procedure similar to that of Example 3. However, the composition of ME #1 was different (comparative Example 1D (from Example 1) was used) and contained a crosslinker, ALMA. Also, the PVOH solution was relocated to be blended into the Stage 2 monomer emulsion (ME #2 (comparative Example 2D (from Example 2))) and gradually metered into the reactor during the Stage 2 polymerization. Basic characteristics: solid: 44.0%, pH: 7.39.

### Example 7 (Comparative)

Polymer E was formed by a procedure similar to that of Example 4. However, the composition of ME #1 was different (comparative Example 1E (from Example 1) was used) and contained a crosslinker, ALMA. Basic characteristics: solid: 43.6% pH: 7.35.

### Example 8

Latexes produced in Examples 3-7 were converted to water redispersible polymer powders via spray drying. The procedure was as follows. 1050 g of latex (44 wt %)(e.g., Examples 3-7) was blended with a slurry of 4.6 g of Ca(OH)₂ dispersed in 50 g of water along with an additional 600 g water. The pH was raised to 12-13 and the solid content was ca. 27.5 wt % The neutralized emulsion was then spray dried in a Niro Atomizer laboratory spray dryer (GEA Process Engineering Inc., Columbia, Md.) equipped with a nozzle (SU4 from Spray Systems Company, Wheaton, Ill.). The inlet temperature was 175-185*C, and the outlet temperature was 62-66° C. The feed rate was 60-80 g/min. Kaolin clay (KAMIN™ HG-90 available from KaMin LLC, Macon, Ga.) was the flow aid and targeted to be 12-14 wt % in the spray dried powders. Basic characteristics of the resultant RDPs are below in TABLE 3:

TABLE 3

| | | | Powder C | Powder D | Powder E |
|---|---|---|---|---|---|
| Characteristics | Powder A | Powder B | (comparative) | (comparative) | comparative |
| Moisture content (%) | 1.97 | 1.97 | 1.50 | 1.64 | 1.71 |
| Ash content (%) | 10.98 | 11.51 | 11.75 | 12.74 | 11.58 |
| Flow aid (%) | 12.90 | 13.52 | 13.81 | 14.97 | 13.61 |
| Sedimentation (mm) | 5 | 5 | 4 | 4 | 3 |
| 1 h | | | | | |
| Sedimentation (mm) | 15 | 15 | 12 | 10 | 9 |
| 24 h | | | | | |

The degree of grafting was studied by capillary zonal electrophoresis (CZE). TABLE 4 illustrates particle size and intrinsic mobility of the small mode of the latex precursors, which may be affected by the degree of grafting:

TABLE 4

| | | | Powder C | Powder D | Powder E |
|---|---|---|---|---|---|
| | | | (compar- | (compar- | (compar- |
| | Powder A | Powder B | ative) | ative) | ative) |
| μ_{small,ep,} | −8.6 ± 0.1 | −7.7 ± 0.1 | −8.7 ± 0.1 | −7.8 ± 0.1 | −7.6 ± 0.1 |
| cm/min* | | | | | |

Reported values in TABLE 4 are the average of three measurements. Errors represent 95% confidence intervals.

The drawing is a diagram characterizing the degree of grafting in RDPs substantially similar to those of TABLE 3. For alkali-soluble resins (ASR) grafting, “high” is exhibited by 78.3 MMA/1.5 ALMA/20.2 MAA as the shell composition (e.g., ME #1), in which allyl methacrylate (ALMA) is the crosslinker. For example, Powders C-E exhibit high ASR grafting. “Low” ASR grafting is exhibited by 79.8 MMA/20.2 MAA as the shell composition (e.g., ME #1), which contains no chemical crosslinker. For example, Powders A&B exhibit low ASR grafting.

A low level of PVOH grafting is exhibited when PVOH is blended after the Stage 2 polymerization (e.g., cob blends) (e.g., Powder A and Powder C (comparative)).

An intermediate level of PVOH grafting is exhibited when PVOH is blended in the Stage 2 monomer emulsion (ME #2) and gradually fed during the Stage 2 polymerization (e.g., Powder D (comparative)).

A high level of PVOH grafting is exhibited when all the PVOH is added in the kettle before the Stage 2 polymerization (e.g., Powder B aid Powder E (comparative)).

### Example 9

RDPs produced in Example 8 were subjected to drymix formulation and application testing. The RDPs were blended in a ternary hydraulic binder (ordinary Portland cement (OPC)+calcium aluminate cement+gypsum, for fast setting) drymix formulation and the performance was evaluated for both the wet mortars (water demand, density, workability) aid cured membranes (tensile and elongation, crack bridging, water uptake). Results are given in TABLE 5:

TABLE 5

| | | | Powder C | Powder D | Powder E |
|---|---|---|---|---|---|
| Performance | Powder A | Powder B | (comparative) | (comparative) | (comparative) |
| Mortar Prep | 0.310 | 0.310 | 0.310 | 0.265 | 0.310 |
| Water Demand | | | | | |
| Mortar Prep | 1.28 | N.M. | 1.32 | 1.20 | 1.24 |
| Mortar p (g/mL) | | | | | |
| 7 days NC | 1.10 | 1.50 | 1.43 | 1.20 | 1.87 |
| Tensile strength (MPa) | | | | | |
| 7 days NC | 8.8 ± 0.8 | 15.7 ± 2.3 | 7.1 ± 1.0 | 4.8 ± 1.4 | 4.3 ± 1.7 |
| Elongation at break (%) | | | | | |
| 7 days NC/7 days water | 0.20 | 0.20 | 0.15 | 0.17 | 0.18 |
| Tensile strength (MPa) | | | | | |
| 7 days NC/7 days water | 32.0 ± 2.8 | 12.0 ± 1.4 | 5.7 ± 0.5 | 5.9 ± 1.9 | 4.6 ± 0.7 |
| Elongation at break (%) | | | | | |
| Crack bridging at RT | 154 | 252 | 144 | 103 | N.M. |
| Max force (N) | | | | | |
| Crack bridging at RT | 0.30 ± 0.2 | 0.94 ± 0.05 | 0.31 ± 0.02 | 0.32 ± 0.14 | N.M. |
| Deformation at max | | | | | |
| force (mm) | | | | | |

Cementitious compositions comprising Powder A and Powder B exhibited superior results for elongation at break after 7 days of curing at NC and an additional 7 days of water immersion. Cementitious compositions comprising Powder B also exhibited superior results for elongation at break after 7 days of curing at NC and deformation at max force in crack bridging.

Referring to Examples 8 and 9, Powder E showed the best redispersibility. Without being bound by theory, the grafting degree of both ASR and PVOH was high, and thus the colloidal stability was expected to be favorable. However, Powder B showed the best overall mechanical properties for the tensile and elongation of membranes after 7 days at normal condition, after additional 7 days in water immersion, and crack bridging at RT when used in cementitious compositions.

Without being bound by theory, minimizing polymer particle adsorption onto cement grains early in the cure may lead to better polymer film formation late in cure when free water content is low, this better film formation may lead to better mechanical properties. Grafted PVOH may act as a stabilizer helping to minimize the polymer particle adsorption onto cement. Covalently-grafted ASR would promote the interaction of cement grans and latex particles, while ASR that is only physically adsorbed on the polymer particle may desorb from the polymer particles and adsorb onto cement. ASR adsorbed on cement would then decrease the interaction between polymer particles and cement Thus, high PVOH grafting and low ASR grafting may deliver superior results (e.g., Powder B).

1. An emulsion polymer, comprising:
a shell portion comprising an alkali soluble resin (ASR);
a core portion formed from polymerized units of at least one hydrophobic ethylenically unsaturated monomer, wherein no crosslinker is present when the shell portion and core portion are combined; and
a nonionic water-soluble polymer.

2. The emulsion polymer of claim 1, wherein the ASR is formed from polymerized units of at least one add-functional monomer, anhydride-functional monomer, salts thereof or a combination thereof.

3. The emulsion polymer of claim 1, wherein the ASR is formed from polymerized units of at least one add-functional monomer comprising Methyl methacrylate (MMA) and Methacrylic add (MAA).

4. The emulsion polymer of claim 1, wherein the ASR is formed from polymerized units of at least one add-functional monomer at a level of from about 5 percent to about 50 percent by mass of the total mass of ASR.

5. The emulsion polymer of claim 1, wherein the ASR is formed from polymerized units of at least one add-functional monomer at a level of from about 10 percent to about 30 percent by mass of the total mass of ASR.

6. The emulsion polymer of claim 1, wherein the glass transition temperature (Tg) of the ASR in the acid form is about 70° C. to about 140° C.

7. The emulsion polymer of claim 1, wherein the shell portion has a weight average molecular weight of 50,000 or less.

8. The emulsion polymer of claim 1, wherein the at least one hydrophobic ethylenically unsaturated monomer comprises alkyl (meth)acrylate, styrene, and/or a vinyl ether.

9. The emulsion polymer of claim 1, wherein the Tg of a polymer produced from the core portion is about −50° C. to about 60° C.

10. The emulsion polymer of claim 1, wherein the mass ratio of ASR:core is in a range of about 2:98 to about 50:50.

11. The emulsion polymer of claim 1, wherein the mass ratio of nonionic water-soluble polymer to the ASR plus core is in a range of about 0.5 parts to about 20 parts nonionic water-soluble polymer to about 100 parts ASR plus core.

12. The emulsion polymer of claim 1, wherein the mass ratio of nonionic water-soluble polymer to ASR plus core is in a range of about 1 parts to about 10 parts.

13. The emulsion polymer of claim 1, wherein the nonionic water-soluble polymer is polyvinyl alcohol (PVOH).

14. The emulsion polymer of claim 1, wherein the emulsion polymer exhibits a low level of ASR grafting and a high level of PVOH grafting.

15. A cementitious composition, comprising:
the emulsion polymer of claim 1; and
a ternary hydraulic binder.

16. A spray dried powder, comprising:
the emulsion polymer of claim 1; and
a flow aid present in a range of about 1% to about 30% by weight of the spray dried powder.

17. A cementitious composition, comprising:
the spray dried powder of claim 16; and
a ternary hydraulic binder.

18. A cementitious composition, comprising:
the emulsion polymer of claim 14; and
a ternary hydraulic binder.

19. A spray dried powder, comprising:
the emulsion polymer of claim 14; and
a flow aid present in a range of about 1% to about 30% by weight of the spray dried powder.

20. A cementitious composition, comprising:
the spray dried powder of claim 19; and
a ternary hydraulic binder.
